(19) United States
(12) Patent Application Publication
(10) Pub. No.: US 2023/0159804 A1
(43) Pub. Date: May 25, 2023

(54) Polyurethane Reactive Hot Melt With Long Pot-Life Under Heat

(71) Applicant: Henkel AG & Co. KGaA, Duesseldorf (DE)

(72) Inventors: Yingjie Li, Batavia, IL (US); Shuhui Qin, Palatine, IL (US); Uwe Franken, Duesseldorf (DE)

(21) Appl. No.: 18/157,866

(22) Filed: Jan. 23, 2023

Related U.S. Application Data
(63) Continuation of application No. PCT/US2021/044257, filed on Aug. 3, 2021.
(60) Provisional application No. 63/066,052, filed on Aug. 14, 2020.

(51) Int. Cl. C09J 175/06

(52) U.S. Cl. CPC C09J 175/06

(57) ABSTRACT

Disclosed is a moisture reactive hot melt adhesive composition prepared from a combination comprising a polyisocyanate; a polyol; a MA-SCA acid; one or both of an inorganic filler or an organosilane; optionally a thermoplastic polymer; and optionally one or more additives. Useful polyols include poly(hexanediol adipate), a polyester diol having a structure of Formula 1 or of Formula 2 and combinations thereof. Formula 1 is:

H—[O(CH₂)ₘOOC(CH₂)ₙCO]ₖ—O(CH₂)ₘ—OH;

m and n are each an even integer; m+n =8; m and n are each independently selected from 2, 4 or 6; k is an integer from 9 to 55; and the polyol of Formula 1 has a number average molecular weight of about 2,000 to about 11,000. Formula 2, a polycaprolactone polyol, is:

HO—[(CH₂)₅COO]ₚ—R₁—[OOC(CH₂)₅]₁—OH;

R₁ is an initiator such as 1,4′-butanediol, 1,6′-hexanediol, or ethylene glycol; p is an integer from 0 to 96; q is an integer from 0 to 96; p+q=16 to 96; and the polyol has a number average molecular weight of about 2,000 to about 11,000 or less.

### TECHNICAL FIELD

This disclosure relates generally to moisture reactive polyurethane hot melt adhesives and more particularly to moisture reactive polyurethane hot melt adhesives having low aged viscosity increase and improved pot life and/or improved adhesion to substrates.

### BACKGROUND OF THE INVENTION

This section provides background information which is not necessarily prior art to the inventive concepts associated with the present disclosure.

Hot melt adhesives are solid at room temperature but, upon application of heat, they melt to a liquid or fluid state in which form they are applied to a substrate. On cooling, the adhesive regains its solid form. One class of hot melt adhesives are thermoplastic hot melt adhesives. Thermoplastic hot melt adhesives are generally thermoplastic and can be repeatedly heated to a fluid state and cooled to a solid state. Thermoplastic hot melt adhesives do not crosslink or cure; the hard phase(s) formed upon cooling the thermoplastic hot melt adhesive imparts all of the cohesion strength, toughness, creep and heat resistance to the final adhesive. Naturally, the thettnoplastic nature limits the upper temperature at which such adhesives can be used.

Another class of hot melt adhesives are curable or reactive hot melt adhesives. Reactive hot melt adhesives start out as theanoplastic materials that can be repeatedly heated to a molten state and cooled to a solid state. However, when exposed to appropriate conditions the reactive hot melt adhesive crosslinks and cures to an irreversible solid form. One class of reactive hot melt adhesives are polyurethane hot melt adhesives. Polyurethane hot melt adhesives comprise isocyanate terminated polyurethane prepolymers that react to chain-extend, forming a new polymer. Polyurethane prepolymers are conventionally obtained by reacting polyols with isocyanates. The polyurethane prepolymers cure through the diffusion of moisture from the atmosphere or moisture on the substrates into the adhesive, and subsequent reaction. The reaction of moisture with residual isocyanate forms carbamic acid. This acid is unstable, decomposing into an amine and carbon dioxide. The amine reacts rapidly with isocyanate to form a urea. The final adhesive product is a crosslinked material polymerized primarily through urea groups and urethane groups.

Reactive hot melt adhesives must be maintained at molten temperatures during use. However, even when kept under generally anhydrous conditions reactive hot melt adhesives will slowly increase in viscosity when maintained in a molten state. Eventually the equipment must be shutdown and cleaned to remove the high viscosity hot melt adhesive. In very undesirable cases the reactive hot melt adhesive can gel or phase separate in equipment during use. Either situation requires equipment shutdown, disassembly, cleaning and possibly replacement of parts that cannot be cleaned of the gelled hot melt adhesive. Reactive hot melt adhesives desirably possess heat stability, that is the ability to resist changes in viscosity over time when maintained in a molten state. Naturally, any gelling or phase separation of the reactive hot melt adhesive is considered a failure.

Additives are commonly included in reactive hot melt adhesive formulations. However, large amounts of additives such as fillers negatively affect most reactive polyurethane hot melt adhesives and can substantially reduce the heat stability to undesirable levels. It would be desirable to provide a reactive polyurethane hot melt adhesive that includes high levels of non-fossil fuel based, sustainable, renewable additives while maintaining heat stability.

### SUMMARY OF THE DISCLOSURE

This section provides a general summary of the disclosure and is not a comprehensive disclosure of its full scope or all features, aspects or objectives.

In one embodiment the disclosure provides a moisture reactive hot melt adhesive composition prepared from a combination comprising an organic polyisocyanate, at least one polyol, a MA-SCA acid, and at least one of an inorganic filler or an organosilane.

In one embodiment the combination used to prepare the moisture reactive hot melt adhesive composition comprises a thermoplastic polymer.

In one embodiment the polyol in the combination used to prepare the moisture reactive hot melt adhesive composition comprises a polyether polyol, a polyester polyol or both a polyether polyol and a polyester polyol.

In one embodiment the combination used to prepare the moisture reactive hot melt adhesive composition comprises a polyester polyol that is a polyester diol having a structure of Formula 1 or of Formula 2.
Formula 1 is:

H—[O(CH₂)ₘOOC(CH₂)ₙCO]ₖ—O(CH₂)ₘ—OH;

m and n are each an even integer; m+n=8; m and n are each independently selected from 2, 4 or 6; k is an integer from 9 to 55; and the polyol of Formula 1 has a number average molecular weight of about 2,000 to about 11,000.
Formula 2 is:

HO—[(CH₂)₅COO]ₚ—R₁—[OOC(CH₂)₅]_{q}—OH;

R₁ is an initiator such as 1,4′-butanediaol, 1,6′-hexanediol, or ethylene glycol; p is an integer from 0 to 96; q is an integer from 0 to 96; p+q=16 to 96; and the polyol has a number average molecular weight of about 2,000 to about 11,000. Formula 2 is a polycaprolactone diol, which is a specialized form of a polyester diol. Thus, hereinafter when referring to a polyester diol according to this disclosure it is intended to include all diols having the structures of Formula 1 or 2 and/or mixtures of diols wherein each diol in the mixture has a structure of Formula 1 or 2. In this embodiment polyester polyols not having the structure of Formula 1 and/or Formula 2 are preferably excluded from the composition.

In one embodiment the combination comprises the polyester diol according to Formula 1 or 2 having a number average molecular weight of from 2,000 to 11,000 and the polyester diol is present in an amount of from 10 to 35% by weight based on the total adhesive weight.

In one embodiment the combination comprises the polyether polyol having a number average molecular weight of from 1,500 to 6,000 and the polyether polyol is present in an amount of from 15 to 40% by weight based on the total adhesive weight.

In one embodiment the combination comprises the polyether polyol which is a polypropylene glycol.

In one embodiment the combination comprises the thermoplastic polymer which is an acrylic polymer having a weight average molecular weight of from 30,000 to 80,000 and the acrylic polymer is present in an amount of from 10 to 40% by weight based on the total adhesive weight.

In one embodiment the combination comprises the thermoplastic polymer is an acrylic polymer having a glass transition temperature of from 35 to 85° C. and a hydroxyl number of less than 8.

In one embodiment the polyisocyanate is present in an amount of from 5 to 40% by weight based on the total adhesive weight.

In one embodiment the polyisocyanate comprises 4,4′-methylenebisphenyldiisocyanate (4,4′-MDI).

In one embodiment the adhesive comprises 10 to 50 wt. % of inorganic filler based on the total adhesive weight.

In one embodiment the adhesive comprises calcium carbonate filler.

In one embodiment the hot melt adhesive composition further comprises an additive selected from an additional filler, a plasticizer, a catalyst, a colorant, a rheology modifier, a flame retardant, an UV pigment, a nanofiber, a defoamer, a tackifier, a curing catalyst, an anti-oxidant, a stabilizer, a thixotropic agent and mixtures thereof.

In one embodiment the hot melt adhesive composition comprises an organosilane adhesion promoter.

In one embodiment the disclosure comprises an article of manufacture comprising the disclosed hot melt adhesive in cured or uncured form.

In one embodiment the disclosure comprises cured reaction products of the disclosed hot melt adhesive.

The disclosed compounds include any and all isomers and stereoisomers. In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in the prior art compositions or that are otherwise not necessary to the achievement of the function and/or objective of the present disclosure.

The word “about” or “approximately” as used herein in connection with a numerical value refer to the numerical value +10%, preferably ±5% and more preferably ±1% or less.

These and other features and advantages of this disclosure will become more apparent to those skilled in the art from the detailed description of a preferred embodiment. The drawings that accompany the detailed description are described below.

### DETAILED DESCRIPTION OF A PREFERRED EMBODIMENT

The singular forms “a”, “an” and “the” include plural referents unless the context clearly dictates otherwise.

About or “approximately” as used herein in connection with a numerical value refer to the numerical value ±10%, preferably ±5% and more preferably ±1% or less.

At least one, as used herein, means 1 or more, i.e., 1, 2, 3, 4, 5, 6, 7, 8, 9, or more. With reference to an ingredient, the indication refers to the type of ingredient and not to the absolute number of molecules. “At least one polymer” thus means, for example, at least one type of polymer, i.e., that one type of polymer or a mixture of several different polymers may be used.

The terms “comprising”, “comprises” and “comprised of” as used herein are synonymous with “including”, “includes”, “containing” or “contains”, and are inclusive or open-ended and do not exclude additional, non-recited members, elements or method steps.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

Preferred and preferably are used frequently herein to refer to embodiments of the disclosure that may afford particular benefits, under certain circumstances. However, the recitation of one or more preferable or preferred embodiments does not imply that other embodiments are not useful and is not intended to exclude those other embodiments from the scope of the disclosure.

Unless specifically noted, throughout the present specification and claims the term molecular weight when referring to a polymer refers to the polymer's number average molecular weight (Mn). The number average molecular weight Mₙ can be calculated based on end group analysis (OH numbers according to DIN EN ISO 4629, free NCO content according to EN ISO 11909) or can be determined by gel permeation chromatography according to DIN 55672 with THF as the eluent. If not stated otherwise, all given molecular weights are those determined by gel permeation chromatography.

An adhesive's open time refers to the time during which an adhesive can bond to a material.

Polyurethane hot melt adhesives find widespread use in panel lamination procedures. They provide good adhesion to a variety of materials and good structural bonding. Their lack of a need for a solvent, rapid green strength, and good resistance to heat, cold and a variety of chemicals make them ideal choices for use in the building industries. In particular they find use in recreation vehicle panel lamination and doors. Because forming these structures can involve complex laminations it is important to have long open times of 6 minutes or greater and high green strength. In addition, the final strength needs to be maintained even when the cured assembly is exposed to temperature extremes. It is desirable to provide reactive polyurethane hot melt adhesives which retain cured strength at higher temperatures than prior formulations to allow for additional uses.

The present disclosure is directed toward providing reactive polyurethane hot melt adhesives that incorporate high levels of sustainable, renewable, non-fossil fuel components such as fillers while maintaining their desirable properties such as heat stability.

The disclosed hot melt adhesives are a reaction product of a mixture comprising: an organic polyisocyanate, a polyol, a MA-SCA, and at least one of an inorganic filler or an organosilane. The mixture can optionally comprise one or more of a thermoplastic polymer, a catalyst, and additives. Nonreactive components such as inorganic filler and theunoplastic polymer can also be added to the reaction product after the reaction. Preferably the hot melt adhesive is free of organic solvents, water and photoinitiators.

Organic polyisocyanates that can be used include alkylene diisocyanates, cycloalkylene diisocyanates, aromatic diisocyanates and aliphatic-aromatic diisocyanates. Examples of isocyanates for use in the present disclosure include, by way of example and not limitation: methylenebisphenyldiisocyanate (MDI), isophorone diisocyanate (IPDI), hydrogenated methylenebisphenyldiisocyanate (HMDI), toluene diisocyanate (TDI), ethylene diisocyanate, ethylidene diisocyanate, propylene diisocyanate, butylene diisocyanate, trimethylene diisocyanate, hexamethylene diisocyanate, cyclopentylene-1,3-diisocyanate, cyclo-hexylene-1,4-diisocyanate, cyclohexylene-1,2-diisocyanate, 4,4′-diphenylmethane diisocyanate, 2,2-diphenylpropane-4,4′-diisocyanate, xylylene diisocyanate, 1,4-naphthylene diisocyanate, 1,5-naphthylene diisocyanate, m-phenylene diisocyanate, p-phenylene diisocyanate, diphenyl-4,4′-diisocyanate, azobenzene-4,4′-diisocyanate, diphenylsulphone-4,4′-diisocyanate, 2,4-tolylene diisocyanate, dichlorohexa-methylene diisocyanate, furfurylidene diisocyanate, 1-chlorobenzene-2,4-diisocyanate, 4,4′,4″-triisocyanatotriphenylmethane, 1,3,5-triisocyanato-benzene, 2,4,6-triisocyanato-toluene, 4,4′-dimethyldiphenyl-methane-2,2′,5,5-tetratetraisocyanate, and the like. While such compounds are commercially available, methods for synthesizing such compounds are well known in the art. Preferred isocyanate-containing compounds are isomers of methylenebisphenyldiisocyanate (MDI), isophorone diisocyanate (IPDI), hydrogenated MDI (HMDI) and toluene diisocyanate (TDI).

Polyols that can be used include those polyols used for the production of polyurethanes, including, without limitation, polyether polyols, polyester polyols, polycarbonate polyols, polyacetal polyols, polyamide polyols, polyesteramide polyols, polyalkylene polyether polyols, polythioether polyols and mixtures thereof, preferably polyether polyols, polyester polyols, polycarbonate polyols and mixtures thereof.

Useful polyester polyols include those that are obtainable by reacting, in a polycondensation reaction, dicarboxylic acids with polyols. The dicarboxylic acids may be aliphatic, cycloaliphatic or aromatic and/or their derivatives such as anhydrides, esters or acid chlorides. Specific examples of these are succinic acid, glutaric acid, adipic acid, pimelic acid, suberic acid, azelalaic acid, sebacic acid, dodecandioic acid, phthalic acid, terephthalic acid, isophthalic acid, trimellitic acid, phthalic acid anhydride, tetrahydrophthalic acid anhydride, glutaric acid anhydride, maleic acid, maleic acid anhydride, fumaric acid, dimeric fatty acid, dodecane dioic acid and dimethyl terephthalate. Examples of suitable polyols are monoethylene glycol, 1,2-propanediol, 1,3-propanediol, 1,4-butanediol, 3-methylpentane-1,5-diol, neopentyl glycol (2,2-dimethyl-1,3-propanediol), 1,6-hexanediol, 1,8-otaneglycol cyclohexanedimethanol, 2-methylpropane-1,3-diol, diethyleneglycol, triethyleneglycol, tetraethyleneglycol, polyethyleneglycol, dipropyleneglycol, tripropyleneglycol, tetrapropyleneglycol, polypropyleneglycol, dibutyleneglycol, tributyleneglycol, tetrabutyleneglycol and polybutyleneglycol. Alternatively, they may be obtained by ring-opening polymerization of cyclic esters, preferably caprolactone. Polyester polyols are commercially available, for example Piothane polyols available from Panolam Industries International and Dynacoll polyols available from Evonik. Other suppliers include Stepan, COIM and Lanxess. In some embodiments polyhexanediol adipate polyols are preferred.

Useful polyether polyols that can be used include linear and branched polyethers having hydroxyl groups. Examples of the polyether polyol may include a polyoxyalkylene polyol such as polyethylene glycol, polypropylene glycol, polybutylene glycol and the like. Further, a homopolymer and a copolymer of the polyoxyalkylene polyols may also be employed. Particularly preferable copolymers of the polyoxyalkylene polyols may include an adduct of at least one compound selected from the group ethylene glycol, propylene glycol, diethylene glycol, dipropylene glycol, triethylene glycol, 2-ethylhexanediol-1,3, glycerin, 1,2,6-hexane triol, trimethylol propane, trimethylol ethane, tris(hydroxyphenyl)propane, triethanolamine, triisopropanolamine, ethylenediamine and ethanolamine. Most preferably the polyether polyol comprises polypropylene glycol. Preferably the polyether polyol has a number average molecular weight of from 1,500 to 6,000 with a more preferred range of 2,000 to 4,000 Daltons. The polyether polyol may comprise a mixture of polyether polyols.

Useful polycarbonate polyols can be obtained by reaction of carbon acid derivatives, e.g. diphenyl carbonate, dimethyl carbonate or phosgene with diols. Suitable examples of such diols include ethylene glycol, 1,2- and 1,3-propanediol, 1,3- and 1,4-butanediol, 1,6-hexanediol, 1,8-octanediol, neopentyl glycol, 1,4-bishydroxymethyl cyclohexane, 2-methyl-1,3-pro-panediol, 2,2,4-trimethyl pentanedio1-1,3, dipropylene glycol, polypropylene glycols, dibutylene glycol, polybutylene glycols, bisphenol A, bisphenol F, tetrabromobisphenol A as well as lactone-modified diols. In some embodiments the diol component preferably contains 40 to 100 wt % hexanediol, preferably 1,6-hexanediol and/or hexanediol derivatives. More preferably the diol component includes examples that in addition to terminal OH groups display ether or ester groups. The polycarbonate polyols should be substantially linear. However, they can optionally be slightly branched by the incorporation of polyfunctional components, in particular low-molecular polyols. Suitable examples include glycerol, trimethylol propane, hexanetriol-1,2,6, butanetriol-1,2,4, trimethylol propane, pentaerythritol, quinitol, mannitol, and sorbitol, methyl glycoside, 1,3,4,6-dianhydrohexites.

Useful polyols further comprise polyols that are hydroxy-functionalized polymers, for example hydroxy-functionalized siloxanes as well as polyols that comprise additional functional groups, such as vinyl or amino groups.

In one embodiment the reaction mixture comprises polyester diol polymers that have the structure of Formula 1 or Formula 2, either alone or in combination with one or more additional polyols. The polyester diol polymers of Formula 1 or Formula 2 preferably have a number average molecular weight of 2,000 to 11,000 Daltons, more preferably from 2,000 to 10,000, and further preferably from 2,500 to 6,000. For the polyester diol polymers, according to the present disclosure the relationship between the number average molecular weight (Mn), functionality of the polyol (f) and the hydroxyl number of the polyol (OH#) can be expressed by the following equation Mn=(f)*(56100/OH#). Formula 1 is:

H—[O(CH₂)ₘOOC(CH₂)ₙCO]ₖ—O(CH₂)ₘ—OH;

m and n being an even integer; m+n=8; m and n are independently selected from 2, 4 or 6; k is an integer from 9 to 55; and the polyol of Formula I has a number average molecular weight of around 2,000 to 11.000.

Formula 2, the polycaprolactone, is:

HO—[(CH₂)₅COO]ₚ—R₁—[OOC(CH₂)₅]_{q}—OH;

R₁ is an initiator such as 1,4′-butanediaol, 1,6′-hexanediol, or ethylene glycol; p is an integer from 0 to 96; q is an integer from 0 to 96; p+q=16 to 96; and the polyol has a number average molecular weight of around 2,000 to 11,000.

The combination includes an MA-SCA acid. An MA-SCA acid is a subset of multibasic acids having acidic groups connected eventually to a single central atom. Examples of MA-SCA acids include sulfuric acid, phosphonic acid, phosphoric acid, diphosphoric acid (pyrophosphoric acid). Examples of other acids which are not MA-SCA acids under this disclosure and which should not be used in the disclosed compositions include hydrochloric acid, nitric acid, phosphinic acid, p-toluenesulfonic acid, ethanesulfonic acid, methanesulfonic acid, trifluoromethane sulfonic acid, acetic acid, propionic acid, fumaric acid, maleic acid, ethanedioic acid, and adipic acid.

The MA-SCA acids surprisingly lengthen the time a hot melt adhesive can be maintained at operating temperature before the viscosity rises to an objectional level. Put another way, addition of an MA-SCA acid to a hot melt adhesive surprisingly decreases the rate at which that hot melt adhesive's viscosity increases when maintained at an operating temperature.

Polyurethane adhesives and sealants used at room temperature can incorporate large amounts of filler with no problem. However, adding a large amount of filler, for example 10 wt. % or more or 20 wt. % or more, to a hot melt adhesive will decrease heat stability of that hot melt adhesive, in some cases to levels that make the highly filled hot melt adhesive commercially undesirable. Adding an MA-SCA acid to a highly filled hot melt adhesive surprisingly increases heat stability of that highly filled hot melt adhesive. Although the MA-SCA acid might be expected to undesirably interact with the filler no such interactions have been seen.

It is surprising to note that acids structurally similar to MA-SCA acids, such as maleic acid and adipic acid, also contain multiple acidic groups in the molecules. However, because the two acidic groups do not connect eventually to a single central atom (they connect to two different carbon atoms in their cases), they surprisingly decrease stability of a hot melt adhesive under temperature.

It is further surprising that there are no “neutral” acids. MA-SCA acids improve stability of a hot melt adhesive under temperature. Other acids decrease stability of a hot melt adhesive under temperature.

Fillers can optionally be used. Fillers that can be used include inorganic materials such as calcium carbonate, kaolin and dolomite. Calcium carbonate has been referred to as a non-fossil fuel based, sustainable, renewable material. Other examples of suitable fillers can be found in Handbook of Fillers, by George Wypych 3^{rd} Edition 2009 and Handbook of Fillers and Reinforcements for Plastics, by Harry Katz and John Milewski 1978. The inorganic filler is preferably present in an amount of from about 10% to about 50% by weight, more preferably from 20% to 30% by weight based on the total adhesive weight. Prior attempts to utilize large amounts of such fillers have resulted in hot melt adhesives that have short open times and issues such as undesirable increase of the molten hot melt adhesive during use.

Organosilanes can optionally be used. Organosilanes that can be used include amino-silane such as a secondary amino-silane. One attractive silane includes at least two silyl groups, with three methoxy groups bond to each of the silanes hindered secondary amino group or any combination thereof. An example of one such commercially available amino-silane is bis-(trimethoxysilylpropyl)-amine, such as Silquest A-1170. Other examples of useful organosilanes include silanes having a hydroxy functionality, a mercapto functionality, or both, such as 3-aminopropyltrimethoxysilane, 3-aminopropyltriethoxysilane, 3-aminopropyltrismethoxy-ethoxyethoxysilane, 3-aminopropy 1-methy 1-diethoxysilane, N-methyl-3-aminopropyltrimethoxysilane, N-butyl-3-aminopropyltrimethoxysilane, 3-mercaptopropyltrimethoxysilane, 3-mercaptopropyltriethoxysilane, 3-mercaptopropyl-methyl-dimethoxysilane, (N-cyclohexylaminomethyl)methyldiethoxysilane, (N-cyclohexylaminomethyl) triethoxysilane, (N-phenylaminom-ethyl)methyldimethoxysilane, (N-phenylaminomethyl) tri-methoxysilane, N-ethyl-aminoisobutyltrimethoxysilane, 4-amino-3,3-dimethylbutyltrimethoxysilane, N-(n-butyl)-3-aminopropyltriethoxysilane,N-(n-butyl)-3-aminopropylalkoxydiethoxy-silane, bis(3-triethoxysilylpropyl)amine and any combination thereof.

Organosilanes are commercially available from many sources, for example Momentive Performance Materials (Silquest) and Evonik (Dynasylan). Some useful examples include Silquest Alink 15 (N-ethyl-3-trimethoxysilyl-2-methylpropanamine), Silquest Alink 35 (Gamma-isocyanatopropyltrimethoxysilane), Silquest A174NT (Gamma-methacryloxypropyltrimethoxysilane), Silquest A187 (Gamma-glycidoxypropyltrimethoxysilane), Silquest A189 (Gamma-mercaptopropyltrimethoxysilane), Silquest A 597 (Tris(3-(trimethoxysilyl)propyl)isocyanurate), Silquest A1110 (Gamma-aminopropyltrimethoxysilane), Silquest A1170 (Bis(trimethoxysilylpropyl)amine), Dynasylan 1189 (N-butyl-3-aminopropyltrimethoxysilane), Silquest A1289 (bis-(triethoxysilylpropyletrasulfide), and Silquest Y9669 (N-phenyl-gamma-aminopropyltrimethoxysilane).

Thermoplastic polymers can optionally be used. Theinroplastic polymers that can be used include acrylic polymers formed from acrylates, methacrylates and mixtures thereof as known in the art. Acrylic copolymers comprising at least one of methyl methacrylate monomers and n-butyl methacrylic monomers are preferred. Examples of these preferred acrylic copolymers include Elvacite® 2013, which is a methyl methacrylate and n-butyl methacrylate copolymer having a weight average molecular weight of 34,000; Elvacite® 2016, which is a methyl methacrylate and n-butyl methacrylate copolymer having a weight average molecular weight of 60,000; and Elvacite® 4014 which is copolymer of methyl methacrylate, n-butyl methacrylate and hydroxyethyl methacrylate and has a weight average molecular weight of 60,000. The Elvacite® polymers are available from Lucite International. Additional examples of suitable acrylic polymers can be found in U.S. Pat. Nos. 6,465,104 and 5,021,507 herein incorporated by reference. The acrylic polymer may include active hydrogens or not. Preferably the acrylic polymer has a weight average molecular weight of from 30,000to 80,000, more preferably from 45,000 to 70,000. It is preferably present in an amount of from about 10% to 40% by weight, more preferably from 15% to 25% by weight based on the total adhesive weight. The acrylic polymer preferably has an OH number of less than 8, more preferably less than 5. The acrylic polymer preferably has a glass transition temperature Tg of from about 35 to about 85° C., more preferably from 45 to 75° C.

The adhesive formulation can optionally include one or more of a variety of known hot melt adhesive additives such as catalyst, additional filler, plasticizer, colorant, rheology modifier, flame retardant, UV pigment, nanofiber, defoamer, compatible tackifier, curing catalyst, anti-oxidant, stabilizer, a thixotropic agent such as fumed silica, and the like. Catalysts that can optionally be used include, for example 2,2′-dimorpholinodiethylether, triethylenediamine, dibutyltin dilaurate and stannous octoate. A preferred catalyst is 2,2′-dimorpholinodiethylether. Conventional additives that are compatible with a composition according to this invention may simply be determined by combining a potential additive with the composition and determining if they are compatible. An additive is compatible if it is homogenous within the product at room temperature and at the use temperature.

In one embodiment the hot melt adhesive comprises a reaction product of a mixture comprising:

| | | narrower | preferred |
|---|---|---|---|
| | range | range | range |
| | (wt. %) | (wt. %) | (wt. %) |
| polyisocyanate | 5-40 | 5-25 | 10-20 |
| polyether polyol | 0-40 | 20-35 | 20-30 |
| polyester polyol | 10-50 | 10-40 | 10-20 |
| inorganic filler | 0-70 | 10-50 | 20-30 |
| thermoplastic polymer | 0-50 | 10-40 | 15-25 |
| catalyst | 0-1 | 0.01-1 | 0.02-0.5 |
| MA-SCA acid | 50 to <1,000 ppm | 100 to <800 ppm | < 600ppm |
| organosilane | 0-10 | 0-5 | 0-2.5 |
| additives | 0-50 | 0-35 | 0-25 |

The disclosed hot melt adhesives can be prepared using the following procedure. Note that moisture must be excluded from the polyurethane reaction. The polyols, any thermoplastic polymer and any filler are added to a reactor and placed under heat and vacuum to remove moisture. Once dried polyisocyanate is added to the reactor which is maintained under heat and an inert gas barrier to exclude moisture. After reaction time any catalyst can be added to the reaction product and mixed in. The final product is transferred to a moisture proof container and sealed immediately. Organosilanes, if used, can be added with the polyols or after reaction. It would also be possible to dry the filler and add it to the reaction product.

The hot melt adhesives according to the present disclosure can be applied in a variety of manners including by spraying, roller coating, extruding and as a bead. The disclosed hot melt adhesive can be prepared in a range of viscosities and is stable during storage as long as moisture is excluded. It can be applied to a range of substrates including metal, wood, plastic, glass and textile.

The hot melt adhesives according to the present disclosure will not gel or separate into phases when held at temperatures and for times used in commercial application equipment. In some embodiments the disclosed hot melt adhesives have a viscosity increase of 1000% or less, more typically 500% or less and preferably 200% or less when held at temperatures and for times used in commercial application equipment. Holding samples at 121° C. for 24 hours in a sealed container (e.g. excluding air and moisture) was used to approximate commercial conditions.

The invention also provides a method for bonding articles together which comprises providing the reactive hot melt adhesive in cooled, typically solid, form; heating the reactive hot melt adhesive to a molten form; applying the molten reactive hot melt adhesive composition in molten form to a first article; bringing a second article in contact with the composition applied to the first article; allowing the adhesive to cool and solidify; and subjecting the applied composition to conditions which will allow the composition to fully cure to a composition having an irreversible solid form, the conditions comprising moisture. The hot melt adhesive is typically distributed and stored in its solid form and stored in the absence of moisture to prevent curing during storage. The composition is heated to a molten form prior to application and applied in the molten form. Typical application temperatures are in the range of from about 80° C. to about 145° C. Thus, this disclosure includes reactive polyurethane hot melt adhesive compositions in both its uncured, solid form, as it is typically to be stored and distributed, its molten form after it has been melted just prior to its application and in its irreversibly solid form after curing.

After application, to adhere articles together, the reactive hot melt adhesive composition is subjected to conditions that will allow it to solidify and cure to a composition that has an irreversible solid form. Solidification or setting occurs when the liquid melt begins to cool from its application temperature to room temperature. Curing, i.e. chain extending, to a composition that has an irreversible solid form, takes place in the presence of ambient moisture.

The invention is further illustrated by the following non-limiting examples.

### EXAMPLES

The following components were utilized in the examples that follow.

| | |
|---|---|
| polyisocyanate | 4,4′-diphenylmethane-diisocyanate (MDI) |
| polyether polyol | PPG2000 A polypropylene glycol, number average molecular |
| | weight of 2,000 from Covestro. |
| polyester polyol | poly (butanediol adipate) OH value about 22, Mn about 5000, |
| | available fron Panolam |
| polyester polyol | poly(hexanediol adipate) OH value about 30, Mn about 3500, |
| | available fron Panolam |
| catalyst | 2,2′-dimorpholinildiethylether (DMDEE) available from Huntsman |
| filler | CaCO₃, from Imerys Pigments and Additives |
| thermoplastic polymer | Elvacite 2016 from Lucite |
| MA-SCA acid | phosphoric acid |
| acid | ethanesulfonic acid |
| acid | hydrochloric acid HCl |
| acid | nitric acid |
| MA-SCA acid | sulfuric acid |
| acid | phosphinic acid |
| MA-SCA acid | phosphonic acid |
| MA-SCA acid | diphosphoric acid |
| acid | p-toluenesulfonic acid |
| acid | methanesulfonic acid |
| acid | trifluromethanesulfonic acid |
| acid | acetic acid |
| acid | propionic acid |
| acid | fumaric acid |
| acid | maleic acid |
| acid | ethanedioic acid (oxalic acid) |
| organosilane | Bis(trimethoxysilylpropyl)amine (Silquest A1170) |
| organosilane | N-butyl-3-aminopropyltrimethoxysilane (Dynasylan 1189) |
| organosilane | N-phenyl-gamma-aminopropyltrimethoxysilane (Silquest Y9669) |

The viscosity was measured on a Brookfield DV-I+viscometer with a heated sample cup and using a #27 spindle at 121° C. after 30 minutes equilibration at temperature.

Heat stability was measured using the following aging test. An uncured polyurethane hot melt adhesive is filled into an aluminum tube and the tube is sealed to exclude air and moisture. The tube and sample are thermally aged in an oven at 121 C. for 24 hours. After aging the sample viscosity is measured by using Brookfield viscometer (#27 spindle) before and after the thermal aging and the percentage viscosity increase is recorded. Excluding air and moisture helps prevent reaction of the aging sample with moisture. The aging test is an approximation of how the hot melt adhesive will react when held at molten temperatures over time as would occur during use.

If the sample after thermal aging is gelled or phase separated the viscosity after aging is not measured and the thermal stability is considered to be unacceptable and a fail. If the viscosity increase with acid is less than that for the same composition without the acid, we call this an improvement and call such an acid or acids a “good acid”. If the viscosity increase with an acid or acids is more than that without acid or acids, or the system is gelled, we call such an acid or acids a “bad acid”. If the viscosity increase remains essentially the same with or without such an acid or acids, we call such an acid or acids a “neutral acid”. As shown in the results the acids are either good acids or bad acids. Very surprisingly we failed to find a neutral acid.

Examples were prepared as described below. In each case the materials are moisture reactive so the reactions, packaging and storage were done under conditions to exclude moisture.

### Example 1

### Comparative

194.95 parts of a polypropylene glycol, OH value 56 (PPG 2000), was introduced into a heatable stirred tank reactor with a vacuum connection and 133 parts of Elvacite 2016 acrylic resin, 98 parts of poly(butanediol adipate), OH value 22, were dissolved therein. Moisture was then removed in vacuo over a period of 1.5 hours at 121 C. The reactor was then purged with nitrogen, 65 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 2

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22 and 175 parts of calcium carbonate were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 3

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22 and 175 parts of calcium carbonate were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was then purged with nitrogen and the reaction product was transferred to a moisture proof container and sealed immediately for later test.

### Example 4

### Inventive

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.238 parts of phosphoric acid and 175 parts of calcium carbonate were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was then purged with nitrogen and the reaction product was transferred to a moisture proof container and sealed immediately for later test.

### Example 5

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.609 parts of phosphoric acid and 175 parts of calcium carbonate, were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 6

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.21 parts of ethanesulfonic acid and 175 parts of calcium carbonate were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was then purged with nitrogen and the reaction product was transferred to a moisture proof container and sealed immediately for later test.

### Example 7

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.14 parts of HCl and 175 parts of calcium carbonate were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 8

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.175 parts of nitric acid and 175 parts of calcium carbonate were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 9

### Inventive

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.175 parts of sulfuric acid and 175 parts of calcium carbonate were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 110

### Inventive

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22 and 175 parts of calcium carbonate were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) and 0.175 parts of sulfuric acid were added and stirred for 15 minutes under nitrogen. The reaction product was then transferred to a moisture proof container and sealed immediately for later test.

### Example 11

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.14 parts of phosphinic acid (hypophosphorous acid) and 175 parts of calcium carbonate, were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 12

### Inventive

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.28 parts of phosphonic acid (phosphorous acid) and 175 parts of calcium carbonate, were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 13

### Inventive

194.95 parts of a polypropylene glyco, OH value 56, were introduced into a heatable stirred tank reactor with a vacuum connection and 133 parts of Elvacite 2016 acrylic resin, 98 parts of poly(butanediol adipate), OH value 22, 0.28 parts of phosphoric acid and 175 parts of calcium carbonate were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 14

### Inventive

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22 and 175 parts of calcium carbonate, were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) and 0.28 parts of phosphoric acid were added and stirred for 15 minutes under nitrogen. The reaction product was then transferred to a moisture proof container and sealed immediately for later test.

### Example 15

### Inventive

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.28 parts of diphosphoric acid (pyrophosphoric acid) and 175 parts of calcium carbonate, were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 16

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.14 parts of phosphoric acid, 0.14 parts of ethanesulfonic acid and 175 parts of calcium carbonate, were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 17

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.28 parts of p-toluenesulfonic acid and 175 parts of calcium carbonate, were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 18

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22 and 175 parts of calcium carbonate, were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) and 0.28 parts of p-toluenesulfonic acid were added and stirred for 15 minutes under nitrogen. The reaction product was then transferred to a moisture proof container and sealed immediately for later test.

### Example 19

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.28 parts of ethanesulfonic acid and 175 parts of calcium carbonate, were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 20

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22 and 175 parts of calcium carbonate were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) and 0.28 parts of ethanesulfonic acid were added and stirred for 15 minutes under nitrogen. The reaction product was then transferred to a moisture proof container and sealed immediately for later test.

### Example 21

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.28 parts of methanesulfonic acid and 175 parts of calcium carbonate, were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 22

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate) (diol), OH value 22 and 175 parts of calcium carbonate were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) and 0.28 parts of methanesulfonic acid were added and stirred for 15 minutes under nitrogen. The reaction product was then transferred to a moisture proof container and sealed immediately for later test.

### Example 23

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.28 parts of trifluoromethanesulfonic acid and 175 parts of calcium carbonate were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 24

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22 and 175 parts of calcium carbonate, were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) and 0.28 parts of trifluoromethanesulfonic acid were added and stirred for 15 minutes under nitrogen. The reaction product was then transferred to a moisture proof container and sealed immediately for later test.

### Example 25

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.28 parts of acetic acid and 175 parts of calcium carbonate were melted therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 26

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22 and 175 parts of calcium carbonate were heated therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) and 0.28 parts of acetic acid were added and stirred for 15 minutes under nitrogen. The reaction product was then transferred to a moisture proof container and sealed immediately for later test.

### Example 27

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.28 parts of propionic acid and 175 parts of calcium carbonate were heated therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 28

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22 and 175 parts of calcium carbonate were heated therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) and 0.28 parts of propionic acid were added and stirred for 15 minutes under nitrogen. The reaction product was then transferred to a moisture proof container and sealed immediately for later test.

### Example 29

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.28 parts of fumaric acid and 175 parts of calcium carbonate were heated therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 30

### Comparative

194.95 parts of a polypropylene glycol, OH value 56, were introduced into a heatable stirred tank reactor with a vacuum connection and 133 parts of Elvacite 2016 acrylic resin 98 parts of poly(butanediol adipate), OH value 22, 0.28 parts of maleic acid and 175 parts of calcium carbonate were heated therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 31

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.28 parts of ethanedioic acid (oxalic acid) and 175 parts of calcium carbonate were heated therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 32

### Comparative

194.95 parts of a polypropylene glycol, OH value 56, were introduced into a heatable stirred tank reactor with a vacuum connection and 133 parts of Elvacite 2016 acrylic resin, 98 parts of poly(butanediol adipate), OH value 22, 0.28 parts of ethanedioic acid (oxalic acid) and 175 parts of calcium carbonate were heated therein. Moisture was then removed in vacuo over a period of 1.5 hours at 121° C. The reactor was then purged with nitrogen, 98 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 33

### Comparative

194.95 parts of a polypropylene glycol, OH value 56, were introduced into a heatable stirred tank reactor with a vacuum connection and 133 parts of Elvacite 2016 acrylic resin, 98 parts of poly(hexanediol adipate), OH value 30, were melted therein. Moisture was then removed in vacuo over a period of 1.5 hours at 121° C. The reactor was then purged with nitrogen, 58 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 34

### Comparative

194.95 parts of a polypropylene glycol, OH value 56, were introduced into a heatable stirred tank reactor with a vacuum connection and 133 parts of Elvacite 2016 acrylic resin, 98 parts of poly(hexanediol adipate), OH value 30, and 175 parts of calcium carbonate, were melted therein. Moisture was then removed in vacuo over a period of 1.5 hours at 121° C. The reactor was then purged with nitrogen, 77 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 35

### Inventive

194.95 parts of a polypropylene glycol, OH value 56, were introduced into a heatable stirred tank reactor with a vacuum connection and 133 parts of Elvacite 2016 acrylic resin, 98 parts of poly(hexanediol adipate), OH value 30, 0.28 parts of phosphoric acid and 175 parts of calcium carbonate were heated therein. Moisture was then removed in vacuo over a period of 1.5 hours at 121° C. The reactor was then purged with nitrogen, 77 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 36

### Inventive

194.95 parts of a polypropylene glycol, OH value 56, were introduced into a heatable stirred tank reactor with a vacuum connection and 133 parts of Elvacite 2016 acrylic resin, 98 parts of poly(hexanediol adipate), OH value 30, and 175 parts of calcium carbonate, were melted therein. Moisture was then removed in vacuo over a period of 1.5 hours at 121° C. The reactor was then purged with nitrogen, 77 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) and 0.28 parts of phosphoric acid were added and stirred for 15 minutes under nitrogen. The reaction product was then transferred to a moisture proof container and sealed immediately for later test.

### Example 37

### Comparative

194.95 parts of a polypropylene glycol, OH value 56, were introduced into a heatable stirred tank reactor with a vacuum connection and 133 parts of Elvacite 2016 acrylic resin, 98 parts of poly(hexanediol adipate), OH value 30, 0.28 parts of ethanesulfonic acid and 175 parts of calcium carbonate were heated therein. Moisture was then removed in vacuo over a period of 1.5 hours at 121° C. The reactor was then purged with nitrogen, 77 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 38

### Comparative

194.95 parts of a polypropylene glycol, OH value 56, were introduced into a heatable stirred tank reactor with a vacuum connection and 133 parts of Elvacite 2016 acrylic resin, 98 parts of poly(hexanediol adipate), OH value 30, and 175 parts of calcium carbonate were heated therein. Moisture was then removed in vacuo over a period of 1.5 hours at 121° C. The reactor was then purged with nitrogen, 77 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) and 0.28 parts of ethanesulfonic acid were added and stirred for 15 minutes under nitrogen. The reaction product was then transferred to a moisture proof container and sealed immediately for later test.

### Example 39

### Comparative

194.95 parts of a polypropylene glycol, OH value 56, were introduced into a heatable stirred tank reactor with a vacuum connection and 133 parts of Elvacite 2016 acrylic resin, 98 parts of poly(hexanediol adipate), OH value 30, 0.28 parts of acetic acid and 175 parts of calcium carbonate were heated therein. Moisture was then removed in vacuo over a period of 1.5 hours at 121° C. The reactor was then purged with nitrogen, 77 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) was added and stirred for 15 minutes under nitrogen. The reaction product was then transferred to a moisture proof container and sealed immediately for later test.

### Example 40

### Comparative

194.95 parts of a polypropylene glycol, OH value 56, were introduced into a heatable stirred tank reactor with a vacuum connection and 133 parts of Elvacite 2016 acrylic resin, 98 parts of poly(hexanediol adipate), OH value 30, and 175 parts of calcium carbonate, were melted therein. Moisture was then removed in vacuo over a period of 1.5 hours at 121° C. The reactor was then purged with nitrogen, 77 parts of 4,4′-diphenylmethane-diisocyanate (MDI) were added and the contents of the reactor were stirred for 15 minutes under nitrogen at 121° C., and then 3 hours in vacuo at 121° C. The reactor was purged with nitrogen, 0.77 parts of 2,2′-dimorpholinildiethylether (DMDEE) and 0.28 parts of acetic acid were added and stirred for 15 minutes under nitrogen. The reaction product was then transferred to a moisture proof container and sealed immediately for later test.

The above Examples were tested for initial viscosity at 121° C. and viscosity after aging. The results are summarized in the following table.

| | | | | initial | aged | | |
|---|---|---|---|---|---|---|---|
| | | | acid | viscosity | viscosity | Viscosity | pass/ |
| # | type | multibasic acid | added | at 121 C. | at 121 C. | change (%) | fail |
| 1 | C | no acid; no filler | n/a | 11,750 | 19,500 | 66 | — |
| 2 | C | no acid | n/a | 10,550 | 34,200 | 224 | fail |
| 3 | C | no acid; no catalyst | n/a | 10,600 | 35,200 | 232 | fail |
| 4 | I | 340 ppm phosphoric acid; no catalyst | before | 9,500 | 17,200 | 81 | pass |
| 5 | C | 870 ppm phosphoric acid | before | 10,500 | phase | n/a | fail |
| | | | | | separation | | |
| 6 | C | 300 ppm ethanesulfonic acid; no catalyst | before | 12,700 | gelled | n/a | fail |
| 7 | C | 200 ppm HCl | before | 56,300 | gelled | n/a | fail |
| 8 | C | 250 ppm nitric acid | before | 52,250 | gelled | n/a | fail |
| 9 | I | 250 ppm sulfuric acid | before | 9,600 | 18,400 | 92 | pass |
| 10 | I | | after | 9,850 | 16,000 | 62 | pass |
| 11 | C | phosphinic acid (200 ppm) (hypophosphorous acid) | before | 12,700 | gelled | n/a | fail |
| 12 | I | 400 ppm phosphonic acid (phosphorous acid) | before | 9,850 | 17,630 | 79 | pass |
| 13 | I | 400 ppm phosphoric acid | before | 9,125 | 16,150 | 77 | pass |
| 14 | I | | after | 10,100 | 17,950 | 78 | pass |
| 15 | I | 400 ppm diphosphoric acid (pyrophosphoric acid) | before | 9,400 | 17,390 | 85 | pass |
| 16 | C | 200 ppm phosphoric acid and 200 ppm | before | 12,050 | gelled | n/a | fail |
| | | ethanesulfonic acid | | | | | |
| 17 | C | 400 ppm p-toluenesulfonic acid | before | 10,600 | 130,000 | 1126 | fail |
| 18 | C | | after | 10,350 | 130,550 | 1161 | fail |
| 19 | C | 400 ppm ethanesulfonic acid | before | 19,700 | gelled | n/a | fail |
| 20 | C | | after | 11,900 | gelled | n/a | fail |
| 21 | C | 400 ppm methanesulfonic acid | before | 16,450 | gelled | n/a | fail |
| 22 | C | | after | 11,500 | gelled | n/a | fail |
| 23 | C | 400 ppm trifluromethanesulfonic acid | before | 17,900 | gelled | n/a | fail |
| 24 | C | | after | 10,350 | gelled | n/a | fail |
| 25 | C | 400 ppm acetic acid | before | 15,750 | gelled | n/a | fail |
| 26 | C | | after | 10,500 | gelled | n/a | fail |
| 27 | C | 400 ppm propionic acid | before | 16,500 | gelled | n/a | fail |
| 28 | C | | after | 10,850 | gelled | n/a | fail |
| 29 | C | 400 ppm fumaric acid | before | 9,300 | 38,690 | 316 | fail |
| 30 | C | 400 ppm maleic acid | before | 14,525 | gelled | n/a | fail |
| 31 | C | 400 ppm ethanedioic acid and oxalic acid | before | 10,375 | phase | n/a | fail |
| | | | | | separation | | |
| 32 | C | 400 ppm adipic acid | before | 16,100 | gelled | n/a | fail |
| 33 | C | no acid; no filler | n/a | 13,300 | 22,800 | 71 | — |
| 34 | C | no acid | n/a | 9,750 | 23,750 | 144 | — |
| 35 | I | 400 ppm phosphoric acid | before | 11,100 | 20,200 | 82 | pass |
| 36 | I | | after | 10,250 | 18,350 | 79 | pass |
| 37 | C | 400 ppm ethanesulfonic acid | before | 15,955 | gelled | n/a | fail |
| 38 | C | | after | 11,100 | gelled | n/a | fail |
| 39 | C | 400 ppm acetic acid | before | 16,300 | gelled | n/a | fail |
| 40 | C | | after | 10,550 | gelled | n/a | fail |

before = acid was added before the reaction with polyisocyanate
after = acid was added after the polyisocyanate was reacted with polyols
# = Example number;
I = inventive Example;
C = comparative Example

Examples 1, 2 and 3 show that adding filler to a reactive hot melt adhesive decreases heat stability of that adhesive, even if the composition does not include catalyst.

Example 4 shows that adding about 300 ppm of the MA-SCA phosphoric acid returns the reactive hot melt adhesive composition to a desirable heat stability. However, Example 5 illustrates that adding too much (about 900 ppm) of the same MA-SCA phosphoric acid led to phase separation, a heat stability failure.

Examples 6 to 8 illustrate that not all acids can enhance heat stability, reinforcing the surprising MA-SCA acid result. Examples 11-12, 17-32 and 37-40, again illustrate that enhancement of heat stability is provided by a surprisingly narrow range of acids. Other acids can decrease heat stability of a reactive hot melt adhesive.

Using an MA-SCA acid enhances heat stability. Surprisingly, using a combination of MA-SCA acid and a non MA-SCA acid as in Example 16 does not improve heat stability and can lead to gelling.

Examples 33 and 34 again show that adding filler decreases heat stability. Examples 35 and 36 show that adding about 400 ppm of a good phosphoric acid desirable increases heat stability of the reactive hot melt adhesive composition.

Many acids do not provide any increase in heat stability and may even decrease heat stability. While about 300 ppm of phosphoric acid increased heat stability, similar amounts of ethanesulfonic acid (examples 6, 19, 20, 37, 38), hydrochloric acid (Example 7), nitric acid (Example 8), phosphinic acid (Example 11) toluenesulfonic acid (Examples 17, 18), methanesulfonic acid (Example 21, 22), trifluoromethane acid (Examples 23, 24), acetic acid (Examples 25, 26, 39, 40), propionic acid (Examples 27, 28), fumaric acid (Example 29), maleic acid (Example 30), and adipic acid (Example 32) do not provide the same increased heat stability. Many of these examples had undesirable gelling or phase separation failures.

Additional examples were prepared following the below process and using the following formulation. Percentages are weight percent based on the total composition.

| component | wt. % | wt. % | wt. % |
|---|---|---|---|
| polyisocyanate¹ | 13.1 | 13.0 | 12.9 |
| polyether polyol² | 41.5 | 41.2 | 41.1 |
| polyester polyol³ | 20.1 | 19.9 | 19.8 |
| thermoplastic | 25.2 | 25.0 | 25.0 |
| polymer⁴ | | | |
| catalyst⁵ | 0.12 | 0.12 | 0.12 |
| MA-SCA acid | 0 | 0 | 0.03 |
| organosilane⁶ | 0 | 0.8 | 0.8 |

Note that the totals deviate slightly from 100 wt. % due to rounding of the results.
¹4,4′ MDI
²PPG2000 from Covestro
³Piothane 3500HA from Panolam Industries International
⁴Elvacite 2016 from Lucite
⁵2,2′-dimorpholinildiethylether (Jeffcat DMDEE from Huntsman)
⁶material and amount is shown in the results table.

The disclosed hot melt adhesives can be prepared using the following procedure. Note that moisture must be excluded from the polyurethane reaction. The polyols, any thermoplastic polymer and any filler are added to a reactor and placed under heat and vacuum to remove moisture. Once dried polyisocyanate is added to the reactor which is maintained under heat and an inert gas barrier to exclude moisture. After reaction time any catalyst can be added to the reaction product and mixed in. The final product is transferred to a moisture proof container and sealed immediately. Organosilanes, if used, can be added with the polyols or after reaction. It would also be possible to dry the filler and add it to the reaction product.

Samples were made from the above formulation. The samples were tested for adhesion to different substrates the following procedure. A sample of moisture reactive hot melt adhesive is heated to about 121° C. and extruded onto the surface of a 1 inch by 4 inch strip of untreated substrate (glass, aluminum, stainless steel and ABS). The extruded adhesive bead is about 3 mm in diameter and bonds to the substrate surface automatically. The substrates with attached adhesive are stored at ambient condition (room temperature and humidity) for 5 days to allow full curing. After curing, the adhesive bead is manually peeled off the substrate using a narrow putty knife

The results are summarized in the following table.

| | | | | adhesion | adhesion | adhesion | adhesion |
|---|---|---|---|---|---|---|---|
| # | type | organosilane | MA-SCA acid | to glass | to aluminum | to steel | to ABS |
| 41 | C | none | none | P | P | P/F | G/E |
| 42 | C | none | phosphoric | P | P | G | G |
| 43 | C | none | sulfuric | F | F | F | G |
| 44 | C | Silquest A1170 | none | E | G | G/E | G |
| 45 | I | Silquest A1170 | phosphoric | E | G | G/E | G |
| 46 | I | Silquest A1170 | sulfuric | E | G | E | F/G |
| 47 | C | Dynasylan 1189 | none | E | G | E | G/E |
| 48 | I | Dynasylan 1189 | phosphoric | E | G | G | E |
| 49 | I | Dynasylan 1189 | sulfuric | E | G | E | E |
| 50 | C | Silquest Y9669 | none | E | G | G/E | E |
| 51 | I | Silquest Y9669 | phosphoric | E | E | G | E |
| 52 | I | Silquest Y9669 | sulfuric | E | G/E | G | E |

Adhesion results were assessed as follows: E: Excellent bonding strength; the bond cannot be broken without breaking the substrates or over 50% cohesive failure. G: Good bond; the bond cannot be broken without generating some (less than ⅓) cohesive failure or some minor substrate failure. F: Fair bonding strength; the bond can be broken without either substrate failure or cohesive failure but some force is needed to separate the bond; It is generally 100% adhesive failure. P: Poor bonding strength. The bond can be very easily separated with essentially no force required; adhesive failure.

Example 41 exhibited poor adhesion to glass and aluminum substrates, poor to fair adhesion to steel and good to excellent adhesion to ABS polymer. Adding phosphoric acid only increased adhesion slightly to steel and did not increase adhesion to the other substrates. Adding sulfuric acid increased adhesion slightly to all substrates.

Example 44 included the organosilane Silquest A1170. Adding this organosilane increased adhesion substantially to all substrates compared to Example 41 with the same composition except no organosilane. Adding phosphoric or sulfuric acid did not change adhesion substantially for any substrate.

Example 47 included the organosilane Dynasylan 1189. Adding this organosilane increased adhesion substantially to all substrates compared to Example 41 with the same composition except no organosilane. Adding phosphoric or sulfuric acid did not change adhesion substantially for any substrate.

Example 50 included the organosilane Silquest Y9669. Adding this organosilane increased adhesion substantially to all substrates compared to Example 41 with the same composition except no organosilane. Adding phosphoric or sulfuric acid did not change adhesion substantially for any substrate.

Examples 41 to 52 were tested for initial viscosity at 121° C. and viscosity after aging in a sealed environment excluding air and moisture for 24 hours at 121° C.

| | | | | initial | aged | |
|---|---|---|---|---|---|---|
| | | | | viscosity | viscosity | viscosity |
| # | type | organosilane | MA-SCA acid | (cP) | (cP) | change % |
| 41 | C | none | none | 13,380 | 25,600 | 91 |
| 42 | C | none | phosphoric acid | 10,700 | 22,050 | 106 |
| 43 | C | none | sulfuric acid | 10,800 | 19,300 | 79 |
| 41 | C | none | none | 13,380 | 25,600 | 91 |
| 44 | C | Silquest A1170 | none | 12,180 | 128,300 | 953 |
| 45 | I | Silquest A1170 | phosphoric acid | 10,380 | 68,300 | 558 |
| 46 | I | Silquest A1170 | sulfuric acid | 12,680 | 109,000 | 760 |
| 41 | C | none | none | 13,380 | 25,600 | 91 |
| 47 | C | Dynasylan 1189 | none | 12,080 | 77,750 | 544 |
| 48 | I | Dynasylan 1189 | phosphoric acid | 11,430 | 38,130 | 234 |
| 49 | I | Dynasylan 1189 | sulfuric acid | 11,250 | 34,130 | 203 |
| 41 | C | none | none | 13,380 | 25,600 | 91 |
| 50 | C | Silquest Y9669 | none | 10,100 | 52,100 | 416 |
| 51 | I | Silquest Y9669 | phosphoric acid | 10,700 | 51,100 | 378 |
| 52 | I | Silquest Y9669 | sulfuric acid | 13,450 | 48750 | 262 |

Example 41 had an initial viscosity Of 13,380 cP which increased to 25,600 cP after aging in a closed container for 24 hours at 250° F. This is a viscosity rise of 91%. Adding phosphoric or sulfuric acid to the composition depressed both the initial and aged viscosities.

Example 44, including the organosilane Silquest A1170, had an initial viscosity of 12,180 cP, lower than the comparative sample made with no organosilane. After aging the viscosity was 128,300 cP, an increase of over 900%. Adding phosphoric acid decreased the initial viscosity slightly and decreased the aged viscosity substantially. Adding sulfuric acid increased the initial viscosity slightly and decreased the aged viscosity a small amount.

Example 47, including the organosilane Dynasylan 1189, had an initial viscosity of 12,080 cP, lower than the comparative sample made with no organosilane. After aging the viscosity was 77,750 cP, an increase of over 500%. Adding phosphoric acid decreased the initial viscosity slightly and decreased the aged viscosity substantially. Adding sulfuric acid decreased the initial viscosity slightly and decreased the aged viscosity substantially.

Example 50, including the organosilane Silquest Y9669, had an initial viscosity of 10,100 cP, lower than the comparative sample made with no organosilane. After aging the viscosity was 52,100 cP, an increase of over 400%. Adding phosphoric acid very slightly increased the initial viscosity slightly and very slightly decreased the aged viscosity substantially. Adding sulfuric acid increased the initial viscosity and very slightly decreased the aged viscosity substantially.

The Examples show that adding organosilane to a moisture reactive hot melt adhesive can desirably increase bond strength of that adhesive to a number of substrates. The increased bond strength is accompanied by an undesirable decrease in heat stability of the hot melt adhesive. These large viscosity increases can be problematic when the hot melt adhesive is held at molten temperatures during use. In the worst cases the large viscosity increase will require undesirable equipment be shutdown so the viscous hot melt adhesive can be removed and purged from the equipment.

Adding a MA-SCA acid to a hot melt adhesive that does not include filler or organosilane may provide some small benefit by decreasing initial and aged viscosities. Adding a MA-SCA acid to a hot melt adhesive comprising an organosilane component does not lessen the adhesion improvements provided by the organosilane. Adding a MA-SCA acid to a hot melt adhesive comprising an organosilane component provides unexpected and surprising decreases in the aged viscosity.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

We claim:

1. A moisture reactive hot melt adhesive polyurethane composition that is the product of a mixture comprising a polyisocyanate; a polyol; a MA-SCA acid; one or both of an inorganic filler or an organosilane; optionally a thermoplastic polymer; and optionally one or more additives.

2. A moisture reactive hot melt adhesive composition as recited in claim 1 wherein the polyol is selected from the group consisting of poly(alkyldiol adipate) or a polyester diol having a structure of Formula 1 or of Formula 2;
wherein Formula 1 is:
H—[O(CH₂)ₘOOC(CH₂)ₙCO]ₖ—O(CH₂)ₘ—OH;
m and n are each an even integer; m+n=8; m and n are each independently selected from 2, 4 or 6; k is an integer from 9 to 55; and the polyol of Formula 1 has a number average molecular weight of about 2,000 to about 11,000; and
Formula 2 is:
HO—[(CH₂)₅COO]ₚ—R₁—[OOC(CH₂)₅]_{q}—OH;
R₁ is an initiator; p s an integer from 0 to 96; q is an integer from 0 to 96; p+q=16 to 96; and the polyol has a number average molecular weight of about 2,000 to about 11,000.

3. A moisture reactive hot melt adhesive composition as recited in claim 2 comprising both poly(alkyldiol adipate) and the polyester diol having a structure of Formula 1 or of Formula 2.

4. A moisture reactive hot melt adhesive composition as recited in claim 2 wherein the poly(alkyldiol adipate) is selected from poly(alkyldiol adipate), poly(butanediol adipate) or both.

5. A moisture reactive hot melt adhesive composition as recited in claim 2 wherein R₁ is a residue of a glycol initiator selected from 1,4′-butanediol, 1,6′-hexanediol, ethylene glycol and combinations thereof.

6. A moisture reactive hot melt adhesive composition as recited in claim 2, wherein the polyester diol has a number average molecular weight of from 2,000 to 10,000 and is present in an amount of from 10 to 35% by weight based on the total adhesive weight.

7. A moisture reactive hot melt adhesive composition as recited in claim 1 wherein said polyol is a polyether polyol having a number average molecular weight of from 1,500 to 6,000 and being present in an amount of from 15 to 40% by weight based on the total adhesive weight.

8. A moisture reactive hot melt adhesive composition as recited in claim 1 wherein the polyol comprises at least one polypropylene glycol.

9. A moisture reactive hot melt adhesive composition as recited in claim 1, wherein the thermoplastic polymer is an acrylic polymer having a weight average molecular weight of from 30,000 to 80,000 and is present in an amount of from 10 to 40% by weight based on the total adhesive weight.

10. A moisture reactive hot melt adhesive composition as recited in claim 1, wherein the thermoplastic polymer is an acrylic polymer having a glass transition temperature of from 35 to 85° C. and a hydroxyl number of less than 8.

11. A moisture reactive hot melt adhesive composition as recited in claim 1, wherein said polyisocyanate is present in an amount of from 5 to 40% by weight based on the total adhesive weight; and/or the polyisocyanate comprises 4,4′-methylenebisphenyldiisocyanate (MDI).

12. A moisture reactive hot melt adhesive composition as recited in claim 1, wherein said inorganic filler is present in an amount of from about 10 to 70% by weight based on the total adhesive weight; and/or wherein said inorganic filler is present and comprises calcium carbonate.

13. A moisture reactive hot melt adhesive composition as recited in claim 1, further comprising the additive selected from additional filler, plasticizer, catalyst, colorant, rheology modifier, flame retardant, UV pigment, nanofiber, defoamer, tackifier, curing catalyst, anti-oxidant, adhesion promoter, stabilizer, a thixotropic agent and mixtures thereof.

14. A moisture reactive hot melt adhesive composition as recited in claim 1, further comprising 2,2′-dimorpholinildiethylether (DMDEE).

15. An article of manufacture comprising the moisture reactive hot melt adhesive composition according to claim 1.

16. A method of bonding two substrates together comprising:
providing a first substrate and a second substrate;
providing the hot melt adhesive according to claim 1;
heating the provided adhesive to molten form;
applying the adhesive in molten form to the first substrate;
bringing a second substrate into contact with the adhesive on the first substrate; and
allowing the adhesive to cool and cure to an irreversible solid form.

17. Cured reaction products of the hot melt adhesive composition according to claim 1.
